(19) United States
(12) Patent Application Publication
(10) Pub. No.: US 2004/0205633 A1
(43) Pub. Date: Oct. 14, 2004

(54) Previewing file or document content

(75) Inventors: Anthony E. Martinez, Spicewood, TX (US); Michael D. Rahn, Rochester, MN (US)

Correspondence Address: Jeanine S. Ray-Yarletts, IBM Corporation T81/503, PO Box 12195, Research Triangle Park, NC, 27709, US

(73) Assignee: International Business Machines Corporation, Armonk, NY

(21) Appl. No.: 10/044,737

(22) Filed: Jan. 11, 2002

(51) Int. Cl. G06F 15/00

(52) U.S. Cl. 715/526; 715/501.1

(57) ABSTRACT

An easy-to-use, intuitive previewing technique for enabling users to refresh their memories about the content of Web pages and/or files and other documents by previewing that content. The disclosed techniques enable previewing content without actually navigating to the Web page or without actually opening the file or document. A “previewer” graphic image may be dragged over a hyperlink or file name (or file icon) to signal that a preview of the associated Web page or file should be rendered.

### BACKGROUND OF THE INVENTION

1. Field of the Invention

The present invention relates to computer programming, and deals more particularly with previewing the content of files or other documents (such as Web pages).

2. Description of the Related Art

Millions of people use the public Internet and the subset thereof known as the “World Wide Web” (or simply “Web”) on a daily basis, whether for their personal enjoyment or for business purposes or both. As consumers of electronic information and business services, people now have easy access to sources on a global level. As solutions providers focus on delivering improved Web-based computing, many of the solutions which are developed are adaptable to other distributed computing environments. Thus, references herein to the Internet and Web are for purposes of illustration and not of limitation.

The constant barrage of links encountered while navigating the Web makes it difficult for users to remember and maintain the small subset of links they actually need to use. URLs (Uniform Resource Locators) and page titles, used to locate and describe web pages, typically provide little helpful information about the page content and context, and tend to be difficult to remember. So, when the time comes to find and use specific information on the Web users often find themselves “surfing” for information when they actually want to be doing productive work with that information. Furthermore, if a user manages to remember or locate the home page of the site containing the specific information, after reaching the initial page they will often have to click, search, and drill down into the site trying to reach their goal.

This prior art trial-and-error approach places a tremendous cognitive burden on users, forcing them to remember and compare whole Web pages and the paths and links they have navigated in their short-term memory. Users may find themselves clicking on many links, in a random, untargeted search for a goal. The more they click, the more they may become disoriented trying to remember where they have been and what they saw there. In addition to being frustrating for users, this prior art approach is time-consuming and inefficient.

### SUMMARY OF THE INVENTION

An object of the present invention is to provide techniques to allow users to preview content of Web pages.

Still another object of the present invention is to allow this preview to occur without actually navigating to the Web page.

Another object of the present invention is to provide techniques to allow users to preview content of stored files or documents.

A further object of the present invention is to enable users to more easily and efficiently locate and recall information through use of a visual content preview.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for previewing content. In a first aspect, the present invention comprises a graphic previewer image, which when placed over a representation of content to be previewed causes a preview of that content to be rendered. In a second aspect, the present invention comprises providing a previewer graphic for dragging over a representation of content to be previewed, and rendering a preview of the content to be previewed, responsive to dragging of the provided previewer graphic.

The representation may be a hyperlink and the content to be previewed may be a Web page. The representation may alternatively be a file name or file icon and the content to be previewed may be a stored file.

When the content to be previewed is a Web page, the rendered preview preferably comprises a thumbnail version of the Web page. The rendered preview is preferably rendered within the previewer graphic.

The second aspect may further comprise navigating to the Web page, response to a user's request, and displaying the Web page, responsive to the navigating. The user's request may be signalled by clicking within the previewer graphic. Optionally, the previewer graphic may remain positioned over the displayed Web page.

The present invention will now be described with reference to the following drawings, in which like reference numbers denote the same element throughout.

### BRIEF DESCRIPTION OF THE DRAWINGS

FIG. 1 illustrate a graphic image which may be used to preview content, according to preferred embodiments of the present invention;

FIG. 2 illustrates use of the graphic image of FIG. 1 for previewing Web page content;

FIG. 3 is a close-up of FIG. 2, showing more detail of the previewing capability provided by the present invention; and

FIG. 4 provides a flowchart illustrating logic which may be used to implement a preferred embodiment of the present invention.

### DESCRIPTION OF PREFERRED EMBODIMENTS

The present invention provides techniques for previewing content of Web pages, and these techniques may also be used for previewing content of files or other types of documents. The disclosed techniques enable previewing content without actually navigating to the Web page or without actually opening a file or document (referred to hereinafter as a file for ease of reference). Use of the invention will ease the cognitive burden on users by adding a visual element to aid their search for information, saving the users valuable time and reducing user frustration.

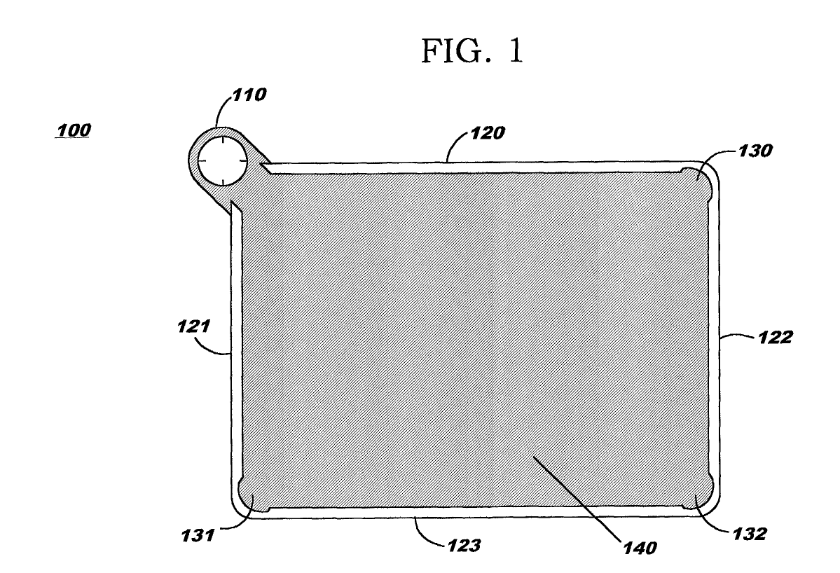

FIG. 1 illustrates a graphic image 100 which may be used to preview content according to the present invention. This graphic image is referred to herein as a “previewer”, and is a very simple visual device that can be dragged about a desktop view, and in and out of graphical windows, to preview files and links. In this manner, users can quickly preview content of a Web page, without requiring the user to click on a link to the page and without requiring the user to traverse the path to each potential Web page. Thus, the user's typical trial-and-error, click-and-search approach to locating content is eliminated. Similarly, users can preview file content without requiring the user to traverse directory paths and open files in various file viewers.

The previewer 100 in FIG. 1 is designed to resemble a window frame, although it will be obvious that many alternative shapes and forms could be used for delivering the function of the present invention without deviating from the inventive concepts disclosed herein. Thus, descriptions herein which refer to use of this window frame shape are for purposes of illustration and not of limitation In preferred embodiments, the previewer may include a virtual link or file sensor 110 at one corner, and can be dragged from all four edges 120, 121, 122, 123 and, if desired, can be resized by dragging on any of the enclosed corners 130, 131, 132. The virtual magnifier 110 functions as a hotspot for detecting URL links (or file names or icons), and preferably contains a visual crosshair for signifying the hotspot to users. The previewer 100 is preferably designed to appear as a translucent window with a gray background 140 (or other plain-colored background), much like a pane of tinted window glass. Thus, the user can effectively see through the graphic image to position it over links and desktop files.

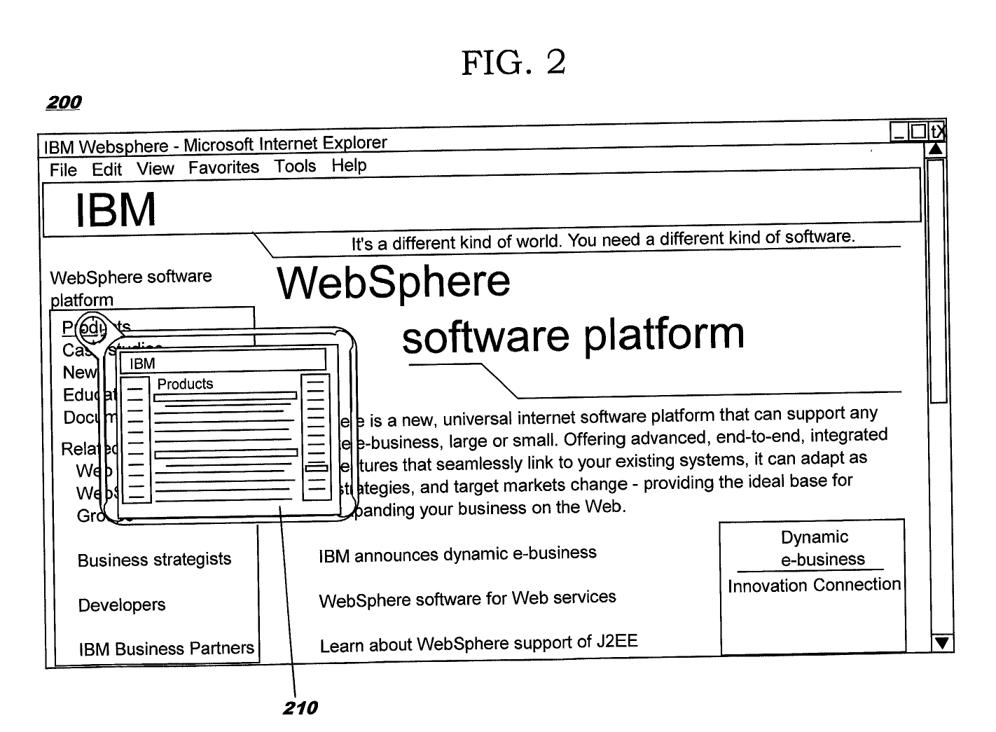

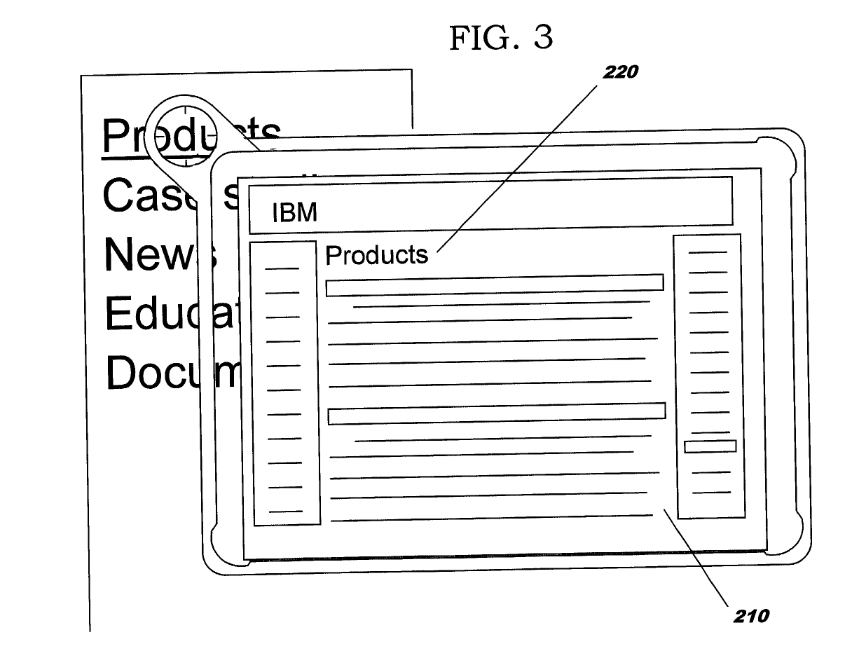

The background 140 preferably remains gray (or dormant) until a user drags the magnifier 110 over a link. When the link is detected, the background 140 becomes active and in preferred embodiments, changes to white (as illustrated in FIGS. 2 and 3) to indicate that the previewer is active. (Links may be detected using prior art techniques which enable, for example, a cursor to change between a pointing arrow and a hand shape.) This active previewer or window then renders a preview of the Web page on the surface of the virtual glass (i.e. within the previewer), also as illustrated in FIGS. 2 and 3 (see element 210). The sample Web page 200 shown in FIG. 2 contains a number of hyperlinks, which can be seen more clearly in the close-up view of FIG. 3. The hyperlinks of this sample page include “Products”, “Case Studies”, “News”, “Education”, and “Documentation”, although the particular hyperlinks are not pertinent to the scope of the present invention. FIG. 2 shows the result 210 of the user having placed the magnifier 110 over the “Products” link, and by inspecting the close-up in FIG. 3, it can be seen that the active previewer or window 210 is displaying a Web page captioned “Products” (see 220). The visual cue shown in the window 210 thus helps users visualize a destination before actually navigating to it (or without navigating to it, in the case where the user determines from the preview that this is not the desired page).

In a similar manner, when the user drags the previewer 100 over a file name or file icon, the previewer becomes active and renders a preview of the file content. The resulting visual cue allows the user to visualize the stored file without having to open a viewer for the file or otherwise perform file opening operations (which may require a number of keystrokes and/or mouse clicks) to view the file contents.

The present invention may be instantiated as a stand-alone utility, which may (for example) be invoked by activating an associated icon; the present invention may alternatively be instantiated as a child or palette window of a Web browser (such as the Netscape Navigator browser from Netscape Communications Corporation, the Internet Explorer browser from Microsoft Corporation, or the Opera browser from Opera Software). The previewer may be selectively displayed, for example in response to a user pressing a function key or selecting a choice from a pull-down menu or a toolbar, thus making its function available for use by the user. In one aspect, the present invention enables the user to navigate to the link being previewed by clicking inside the previewer or by pressing a key such as the “Enter” key. In response, the browser or other viewer software then loads the page. Optionally, the previewer 210 maintains its position over the browser window which displays the loaded page. In another aspect, the present invention may replace the cursor with the previewer 100, so that users do not have to hold a mouse button down to drag the image around the desktop or within the window. This may be especially beneficial for users with dexterity impairments.

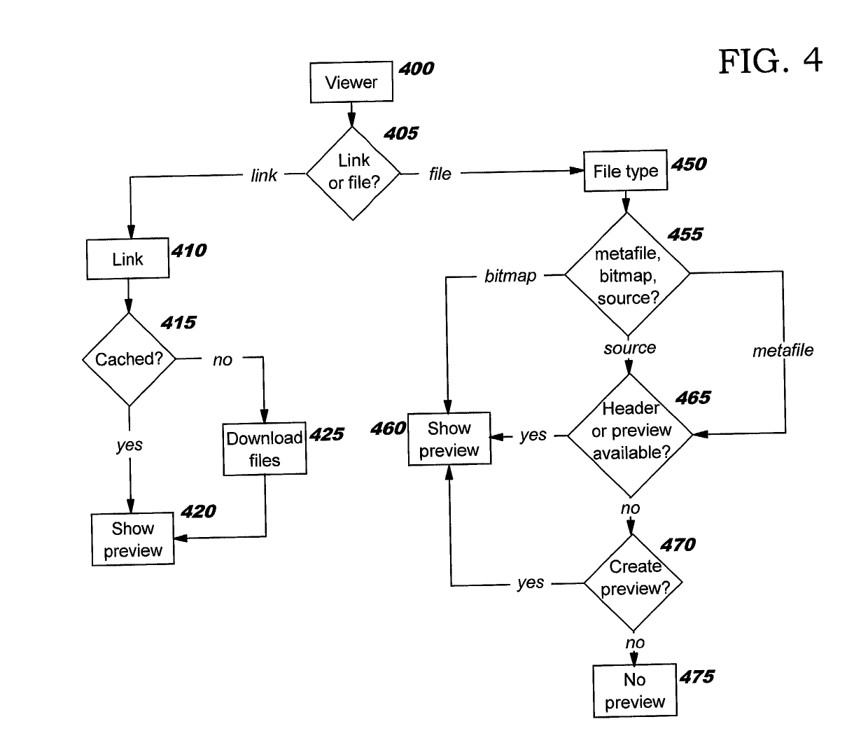

Turning now to FIG. 4, a flowchart is provided which illustrates logic that may be used to implement a preferred embodiment of the present invention. The process begins at Block 400, where the preview function is invoked by the user passing the previewer (see element 100 of FIG. 1) over a link or over a file representation such as a file name or icon. This action is referred to hereinafter as selecting the link or file. Block 405 checks to see if what underlays the previewer is a link or file. If it is a link, processing continues at Block 410; otherwise, when it is a file, processing continues at Block 450.

For the link previewing process which begins at Block 410, preferred embodiments of the present invention exploit previously-cached versions of Web pages and graphics associated with those Web pages. Thus, Block 415 checks to see if the page corresponding to the link selected with the previewer is already cached. If it is not, then Block 425 preferably downloads a copy of the files for this page, storing the files in the browser's cache directory. (In preferred embodiments, the implementation of the present invention and the browser share each other's cached files.) At Block 420, the cached content is leveraged to render a preview of the Web page for the user (as has been discussed above with reference to FIGS. 2 and 3).

When previewing files, the processing which begins at Block 450 first determines the file type of the selected file. Block 455 checks to see if the file type is metafile, bitmap, or source. If the selected file is a bitmap (having an extension such as “.bmp”, “.gif”, or “.jpeg”), then Block 460 displays a preview of the file using its actual contents, as a browser would. (Optionally, the file may be adjusted to fit the size of the previewer, if desired.) Otherwise, for metafile formats (such as a Windows metafile format or Computer Graphics metafile, having extensions of “.wmf” or “.cgm”, respectively) and source files, processing continues at Block 465, which checks to see if a header or preview for the file is already available.

For files in metafile format, the present invention preferably uses the image headers for rendering the preview, and thus if a header exists, processing continues at Block 460 where the preview is rendered using the header. If no header exists, then control transfers to Block 470 to see if a preview can be created. In preferred embodiments, the viewer creates a preview of files without a header using the file contents in a similar manner to how .bmp and .jpeg file previews are created. If no preview can be created, then no preview will be shown, as indicated by Block 475. Otherwise, when a preview was created successfully, the preview is rendered (Block 460).

When Block 455 determines that the content to be previewed pertains to a source file (such as a CorelDraw or Adobe Photoshop file, having extensions of “.cdr” or “.psd”, respectively), then the preview image stored in the source file is preferably used. Thus, if the preview image is available, processing continues at Block 460 where it is rendered. Otherwise, Block 470 checks to see if a preview can be created, and if so, this preview is rendered at Block 460. (In preferred embodiments, the code or “filters” for creating the preview may be specially written for the use with the previewer, or may be created using external rendering plug-in modules that can be called by the previewer. The external plug-ins may, in some cases, be developed by third parties. The preview images which are created for use with the present invention are preferably designed to resemble the “thumbnail sketches”, also referred to as simply “thumbnails”, which are provided in some prior art viewing applications such as Adobe Acrobat.) When no preview can be created, then the preview is not shown (Block 475). The preview processing of the present invention may be used with many different types of source files, which may be vector files or bitmapped image files; zip files; spreadsheets; documents; metafiles; text files; postscript files; and so forth.

The previewer graphic image and the previewing function disclosed herein are to be distinguished from prior art thumbnail sketches. As discussed with reference to Block 460, thumbnail sketches may be used by the present invention, and if so, provide the content of a rendered preview.

As has been demonstrated, the present invention provides an easy-to-use, intuitive previewing technique for enabling users to refresh their memories about the content of Web pages or files. While preferred embodiments have been described herein as supporting both Web pages and files, alternative implementations may support previewing of only Web pages or of only files, without deviating from the scope of the present invention.

As will be appreciated by one of skill in the art, embodiments of the present invention may be provided as methods, systems, or computer program products. Accordingly, the present invention may take the form of an entirely hardware embodiment, an entirely software embodiment or an embodiment combining software and hardware aspects. Furthermore, the present invention may take the form of a computer program product which is embodied on one or more computer-usable storage media (including, but not limited to, disk storage, CD-ROM, optical storage, and so forth) having computer-usable program code embodied therein.

The present invention has been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

While the preferred embodiments of the present invention have been described, additional variations and modifications in those embodiments may occur to those skilled in the art once they learn of the basic inventive concepts. Therefore, it is intended that the appended claims shall be construed to include both the preferred embodiment and all such variations and modifications as fall within the spirit and scope of the invention.

What is claimed is:

1. A content previewer, comprising:
a graphic previewer image;
means for placing the graphic previewer image over a representation of content to be previewed; and
means for rendering a preview of the content to be previewed, responsive to operation of the means for placing.

2. A method of previewing content in a computing system, comprising steps of:
providing a previewer graphic for dragging over a representation of content to be previewed; and
rendering a preview of the content to be previewed, responsive to dragging of the provided previewer graphic.

3. The method of claim 2, wherein the representation is a hyperlink and the content to be previewed is a Web page.

4. The method according to claim 2, wherein the representation is a file name and the content to be previewed is a stored file.

5. The method according to claim 3, wherein the rendered preview comprises a thumbnail version of the Web page.

6. The method according to claim 3, wherein the rendered preview is rendered within the previewer graphic.

7. The method according to claim 3, further comprising steps of:
navigating to the Web page, response to a user's request; and
displaying the Web page, responsive to the navigating.

8. The method according to claim 7, wherein the user's request is signalled by clicking within the previewer graphic.

9. The method according to claim 7, wherein the previewer graphic remains positioned over the displayed Web page.

10. The method according to claim 2, wherein the previewer graphic replaces a cursor of a visual display of the computing system.

11. The method according to claim 2, wherein the rendered preview uses cached information associated with the content to be previewed.

12. The method according to claim 2, wherein the representation is a file icon and the content to be previewed is a stored file.

13. A system for previewing content in a computing system, comprising:
means for providing a previewer graphic for dragging over a representation of content to be previewed;
means for detecting that the provided previewer graphic has been dragged over the representation; and
means for rendering a preview of the content to be previewed, responsive to the means for detecting, wherein the rendered preview is rendered within the previewer graphic.

14. A computer program product for previewing content in a computing system, the computer program product embodied on one or more computer-readable media and comprising:
computer-readable program code means for providing a previewer graphic for dragging over a representation of content to be previewed;
computer-readable program code means for detecting that the provided previewer graphic has been dragged over the representation; and
computer-readable program code means for rendering a preview of the content to be previewed, responsive to the computer-readable program code means for detecting, wherein the rendered preview is rendered within the previewer graphic.
